(19) United States
(12) Patent Application Publication
(10) Pub. No.: US 2026/0213172 A1
(43) Pub. Date: Jul. 23, 2026

(54) HIGH POWER ELECTRODES FOR USE IN ELECTROCHEMICAL CELLS

(71) Applicant: Crimen Tech Private Limited, Thiruvananthapuram (IN)

(72) Inventors: Hari Krishnan D, Trivandrum (IN); Meghna S Nair, Pleasanton, CA (US); Bharat S I, Trivandrum (KL); Gokul G S, Trivandrum (IN)

(73) Assignee: Crimen Tech Private Limited, Thiruvananthapuram, KL (IN)

(21) Appl. No.: 19/033,440

(22) Filed: Jan. 21, 2025

(51) Int. Cl. H01M 4/38; H01M 4/02; H01M 4/04; H01M 4/1395; H01M 4/62; H01M 4/66; H01M 4/75; H01M 10/0525

(52) U.S. Cl. CPC H01M 4/386; H01M 4/0404; H01M 4/0435; H01M 4/1395; H01M 4/622; H01M 4/625; H01M 4/661; H01M 4/75; H01M 10/0525; H01M 2004/021; H01M 2004/027

(57) ABSTRACT

The present disclosure provides a method for manufacturing a high power electrode for an electrochemical cell is disclosed. The method involves mixing silicon oxide (SiOₓ), graphite, binders, additives, and conductive diluents to form an admixture. A water-based solvent, in the range of 40 to 50% by weight, is added to the admixture to create a slurry with a viscosity exceeding 3000 mPa·s. The slurry is uniformly coated onto a conductive foil to form a layer of coat. The coated electrode is then dried at a controlled high temperature ranging from 40° C. to 120° C. to ensure consistent coating, adherence, and optimized porosity. Subsequently, the dried electrode is calendared by applying pressure to reduce the thickness of the coated layer to 70 μm to 90 μm. This process results in a high-power electrode with enhanced mechanical stability, uniform thickness, and optimized pore structure.

### FIELD

The present disclosure relates generally to the manufacturing of electrodes used in electrochemical cells. More particularly the present disclosure relates to manufacturing high power anode for lithium-ion batteries.

### BACKGROUND

The demand for advanced energy storage systems has grown significantly with the increasing adoption of electric vehicles (EVs), plug-in hybrid electric vehicles (PHEVs), and other high-power applications such as air mobility systems and power tools. These applications require batteries that not only offer high energy density, enabling long operating durations, but also high power density, which ensures rapid energy delivery for optimal performance.

Lithium-ion batteries are currently the dominant energy storage technology due to their high energy density and long cycle life. However, conventional battery designs often face a trade-off between energy density and power density. High energy density electrodes typically store more energy but lack the ability to discharge or recharge at high rates, while high power density electrodes sacrifice energy storage capacity to achieve faster discharge and recharge capabilities. This trade-off limits the performance and versatility of batteries for high-power applications.

Negative electrodes, such as those made from graphite, are widely used in lithium-ion batteries due to their stability and high Coulombic efficiency. However, the inclusion of high-capacity materials like silicon or silicon oxide (SiOx) has been explored to improve energy density. These materials exhibit significant volume expansion during charge/discharge cycles, posing challenges for electrode stability, conductivity, and cycle life. Achieving a negative electrode with both high energy and high power characteristics, while maintaining structural integrity and long-term performance, remains a key technical challenge.

Existing efforts to address these challenges include modifying electrode compositions and manufacturing processes. For instance, binders such as polyvinylidene fluoride (PVDF), styrene-butadiene rubber (SBR), and carboxymethyl cellulose (CMC) are used to improve mechanical stability and conductivity. Similarly, conductive additives like carbon nanotubes or carbon black are incorporated to enhance electron transport. Despite these advancements, there remains a need for improved electrode designs that can meet the stringent requirements of both energy density and power density without compromising manufacturability or cost efficiency.

Therefore, there is a continued need for innovative electrode systems that address these limitations and provide high energy storage with fast charging and discharging capabilities, making them ideal for next-generation energy storage solutions.

The present invention aims to overcome these challenges by providing a high-power electrode for electrochemical cells, combining optimized material compositions and manufacturing techniques to deliver enhanced performance for high-power applications.

### OBJECT OF THE INVENTION

The primary object of the present invention is to provide an electrode for use in an electrochemical cell that achieves a balance between high energy density and high power density, enabling superior performance in energy storage and power delivery applications.

Another object of the invention is to develop an electrode composition comprising a combination of silicon oxide (SiOx) and graphite as the electroactive material, optimized to enhance specific capacity while maintaining structural stability during charge and discharge cycles.

A further object is to utilize binders and conductive diluents in precise proportions to ensure enhanced electrical conductivity, improved mechanical integrity, and better cycling performance of the electrode.

Yet another object is to employ a water-based solvent system, making the electrode manufacturing process environmentally friendly, cost-effective, and suitable for scalable production.

An additional object of the invention is to provide an electrode fabrication method that allows for uniform coating on conductive foils, ensuring optimal porosity, consistent thickness, and reliable performance in high-power applications such as electric vehicles, air mobility systems, and power tools.

By achieving these objectives, the invention aims to address the dual challenges of maximizing energy storage and optimizing power delivery for next-generation electrochemical cells.

### SUMMARY

The following summary is illustrative only and is not intended to be in any way limiting. In addition to the illustrative aspects, example embodiments, and features described, further aspects, example embodiments, and features, will become apparent by reference to the drawings and the following detailed description.

The present invention pertains to an advanced electrode or an anode for use in electrochemical cells, designed to achieve high energy density and power density, making it particularly suitable for applications requiring superior energy storage and rapid power delivery. The electrode comprises a combination of silicon oxide (SiOx) with 0.1≤x≤2.00 and graphite, present in 90-95% by weight, as electroactive materials. It further includes binders in 4-6% by weight, selected from options such as polyvinylidene fluoride (PVDF), styrene-butadiene rubber (SBR), carboxymethyl cellulose (CMC), and others, to enhance mechanical stability and compatibility with the silicon and graphite combination. Additionally, the electrode incorporates conductive diluents, including single-walled carbon nanotubes (SWCNT), Super P, Super C65, and polyacrylic acid (PAA), in 2-4% by weight to ensure efficient electron transport and conductivity. A water-based solvent in a range of 40-50% by weight is used to form a slurry, providing an environmentally friendly and cost-effective manufacturing process. Optional additives such as lithium tungsten oxide (LWO) or lithium titanium oxide (LTO), in 5-15% by weight, may also be included to enhance performance and stability.

The electrode is fabricated by preparing a viscous slurry with a viscosity of 3000-6000 mPa·s, coating it onto a conductive foil such as copper, and drying it at incrementally increasing temperatures from 40° C. to 120° C. The coated electrode undergoes a calendaring process to reduce the thickness to 70-90 μm while maintaining optimal pore density. The resulting electrode exhibits a specific energy density of at least 200 Wh/kg, a power density of at least 5000 W/kg, and a discharge capacity of 4 Ah to 5 Ah. It also supports a discharge rate of at least 25 C for pulse power and 11 C for continuous power, enabling continuous discharge at 45 Amperes or more.

The invention provides a method for manufacturing an electrode for electrochemical cells that combines high performance with efficient production. The process begins with mixing silicon oxide (SiOx), graphite, binders, and conductive diluents to form an admixture. A water-based solvent, at 45% by weight, is added to create a slurry with a viscosity exceeding 3000 mPa·s. This slurry is coated onto a conductive foil, such as copper, and subjected to drying at incrementally elevated temperatures ranging from 40° C. to 120° C. The dried electrode is then calendared, applying pressure to reduce the thickness of the coating layer to 70-90 μm while maintaining an optimal pore density between 30% and 75%.

The electrode manufactured using this method exhibits a specific energy density of at least 200 Wh/kg and a power density of at least 5000 W/kg. It achieves a discharge capacity of up to 5 Ah and supports a discharge rate of at least 25 C for pulse power and 11 C for continuous power, enabling it to sustain continuous discharge currents of 45 Amperes or more.

Additionally, the invention includes an electrochemical device featuring a negative electrode in electronic contact with a negative current collector, a positive electrode prepared using the described method, a separator, and an electrolyte. The positive electrode contains silicon oxide (SiOx) and graphite (90-95% by weight), binders (4-6% by weight), and conductive diluents (2-4% by weight), coated and dried on a conductive foil. It may also include additives such as lithium tungsten oxide (LWO) or lithium titanium oxide (LTO) in 5-15% by weight. The device design ensures efficient ionic and electronic contact, making it suitable for high-performance applications in advanced battery technologies. These and other embodiments of the present disclosure are discussed in further detail hereinbelow.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 illustrates a microscopic view of a high power electrode as coated on a conductive foil, according to an example embodiment;

FIG. 2 illustrates a schematic view of an electrochemical device including a high power electrode as an anode, according to an example embodiment;

FIG. 3 illustrates a process flow of manufacturing a high power electrode, according to an example embodiment;

FIG. 4 is flowchart illustrating a method of manufacturing a high power electrode, according to an example embodiment;

FIG. 5 is a graph showing voltage as a function of capacity of the electrode during continuous discharge, according to an example embodiment; and

FIG. 6 is a graph illustrating a pulse discharge of current and voltage of the cell, according to an example embodiment.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Similarly, like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any, and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, elements, and/or components, but do not preclude the presence or addition of one or more other features, integers, steps, operations, elements, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skills in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in ‘addition to the orientation depicted in the figures. For example, if the device in the figures is turned over, elements described as “below”, or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

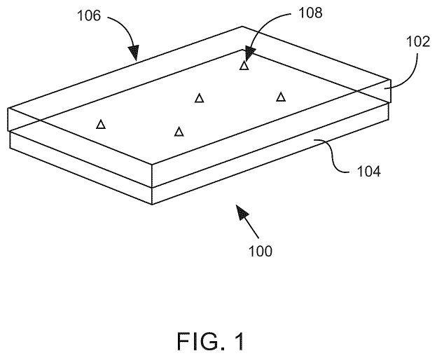

FIG. 1 illustrates a microscopic view 100 of a high power electrode 102, according to an example embodiment. As shown, the electrode 102 includes a composition 102 coated on a copper foil 104. Typically, the composition 102 includes an electroactive material comprising a combination of silicon oxide with a structure of SiOx 0.1≤x≤2.0 and graphite in a range of 90-95% by weight; one or more binders in a range of 4-6% by weight; one or more conductive diluents including SWCNT (single walled carbon nanotubes) , Super P, Super C65, and Poly Acryilic Acid (PAA) in a range of 2 to 4% by weight; and a water-based solvent (e.g. water) in a range of 40-50% by weight. Further, an additive 108 ranging from 5 to 15% by weight is added into the composition 102. The additive is either lithium tungsten oxide (LWO) or lithium titanium oxide (LTO), in a range of 5 to 15% by weight. This composition 102 is coated onto a conductive foil (e.g. the copper foil 104) at a temperature ranging from 40 to 120 degree Celsius and is further dried to form the electrode 106.

Examples, of the one or more binders used are polyvinylidene fluoride (PVDF), styrene-butadiene rubber (SBR), and carboxymethyl cellulose (CMC), Poly(vinyl butyral) (PVB), Polytetrafluoroethylene (PTFE), Polyvinyl Alcohol (PVA), perfluorosulfonic acid polymer, Polyimide (PI), poly(methyl methacrylate) (PMMA), Ethylene Propylene Diene Monomer (EPDM), Polyethylene Oxide (PEO), Polyurethane (PU), Polytetrafluoroethylene (PTFE), Poly(vinyl butyral) (PVB), or latex-based binders. In an example, a latex-based binder is combined with CMC or SBR.

In an example, the composition includes 92% weight of silicon oxide (SiO) and graphite, 1.5% of SWCNT, 1.5% of PAA and Super C65, 6% LWO mixed in a mixer jar, and converted into a viscous slurry by mixing with 45% of water. The viscous slurry has a viscosity of 3000-6000 millipascal-second (mPa·s). The viscous slurry is then coated onto the copper foil 104 and is heated up to a temperature selected between 40 to 120 degrees Celsius. The coated foil is then dried to form the electrode 106. Post drying the coated electrode 106 is subjected to calendaring. During calendaring a pressure ranging from 25-60 MPascal is applied by use of rollers to compress and coat onto the foil. The pressure exerted is such that the porosity and size of pores is maintained to ensure good electric conductivity. A thickness of the combination 102 achieved on the copper foil 104, is 70 μm to 90 μm. Typically, a pore density of 30 to 75% is achieved for the electrode 106. A capacity of the electrode 106 ranges from 3 Ampere hour (Ah) to 5 Ah. A specific energy density of the electrode 106 exhibited is at least 200 Watt hour (Wh)/Kilogram (kg). A power density achieved for the electrode 106, is at least 5000Kg. Further, a discharge rate exhibited by such electrode 106, is at least 25 C for pulse power, and at least 11 C for continuous power, where the electrode continuously discharges at least at least at least at 45 Amperes of current.

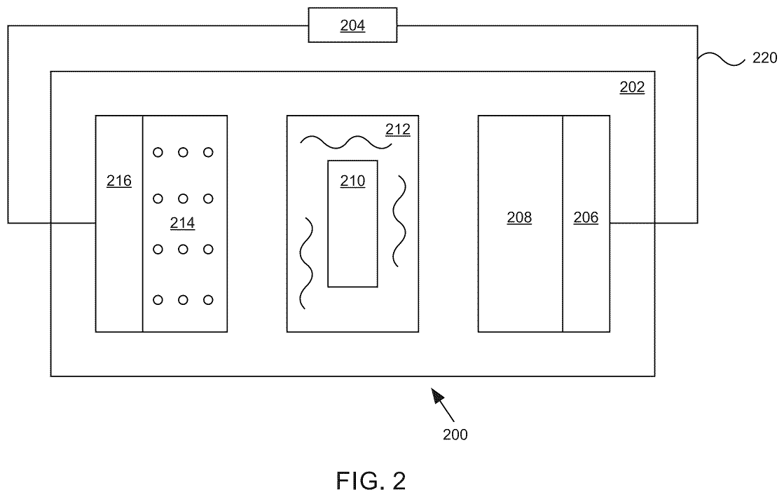

FIG. 2 illustrates a schematic view 200 of an electrochemical device 202 including a high power electrode 208 (106 of FIG. 1) as an anode, according to an example embodiment. As shown, the high power negative electrode 208 or anode 208 is in contact with a negative current collector 206 that is in electric connection with an external circuit that includes a load 204. The negative electrode 208 comprising a combination of an electroactive material comprising a combination of silicon oxide with a structure of SiOx 0.1≤x≤2.0 and graphite in a range of 90-95% by weight, one or more binders in a range of 4-6% by weight, and one or more conductive diluents including SWCNT (single walled carbon nanotubes) , Super P, Super C65, and Poly Acryilic Acid (PAA) in a range of 2 to 4% by weight, in 40-50% of water, wherein the combination is coated and dried on a conductive foil.

The electrochemical device 202 further includes a positive electrode or a cathode 214 in contact with a positive current collector 216. Furthermore, the electrochemical device 202 includes a separator 210 positioned between the negative electrode 208 and the positive electrode 214, and an electrolyte 212 in ionic contact with the positive electrode 214 and the negative electrode 208. In an embodiment, the positive electrode 214, the negative electrode 208 and the separator 210 comprise a sintered subassembly. The positive current collector 216 can be an aluminum current collector, and the negative current collector 206 can be a copper current collector. Current flows between the positive current collector 216 via a load 204 to the negative current collector 206.

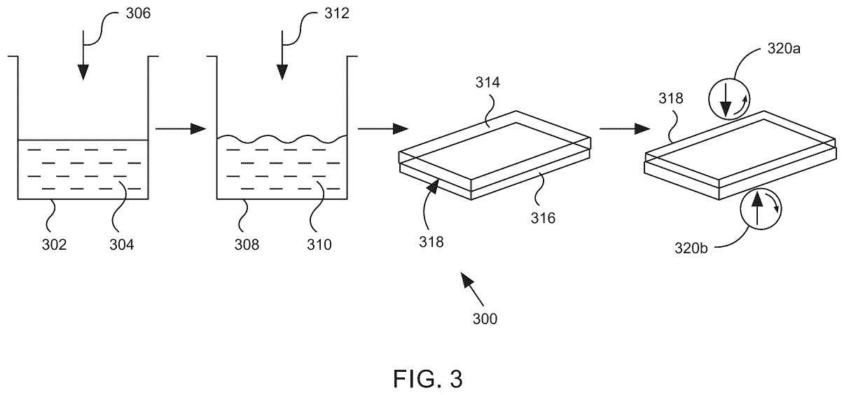

FIG. 3 illustrates a process flow 300 of manufacturing a high power electrode, according to an example embodiment. As shown, a weighted composition of 306 comprising 90-95% of active material, 4 to 6% by weight of binders, 5 to 15% by weight of additives, and 2 to 4 % weight of conductive diluents are mixed in a mixer jar 302 to form an admixture 304. Example of the active material includes silicon oxide with a structure of SiOx 0.1≤x≤2.0 and graphite.

The admixture 304 is then mixed with water 312 (40 to 50% by weight) to form a slurry 310 in a tank 308. The slurry 310 is then coated on a conductive foil 316 to form an electrode 318 that has a layer of coat 314 on the conductive foil 316. The electrode 318 is then calendared in a calendaring machine having at least two precision rollers 320a-320b. The pressure applied on the layer of coat 314, helps bind the active material with the binders, reduce a pore size and increase the porosity of the electrode to enhance electrical conductivity. In an example, a pressure of up to 50 MPascal is applied on the layer of coat 314 to achieve a coating thickness of 70 μm to 90 μm.

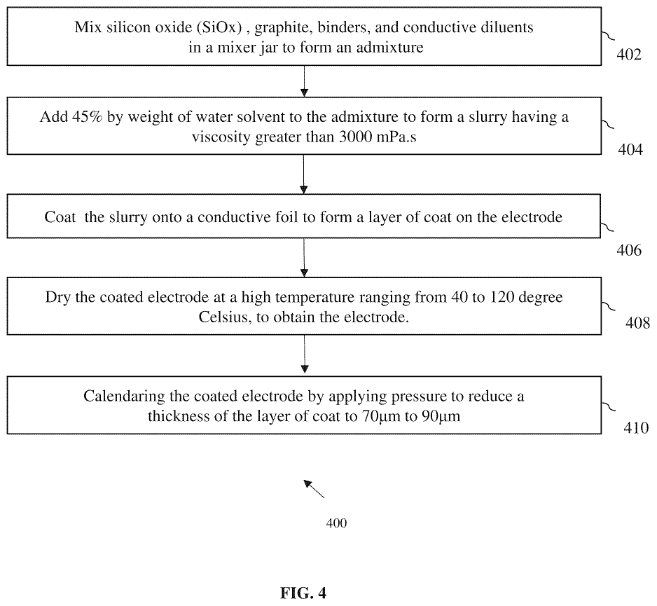

FIG. 4 is flowchart 400 illustrating a method of manufacturing a high power electrode, according to an example embodiment.

At 402, silicon oxide (SiOx) with a structure of SiOx 0.1≤x≤2.0, graphite, binders, additives, and conductive diluents are added in a mixer jar to form an admixture. In an embodiment, SiOx and graphite are added in a ratio of 90-95%, binders in a ratio of 4 to 6 % by weight, additives in a ratio of 5 to 15% by weight, conductive diluents in a ratio of 2 to 4% by weight.

Examples of binders include but are not limited to polyvinylidene fluoride (PVDF), styrene-butadiene rubber (SBR), and carboxymethyl cellulose (CMC), Poly(vinyl butyral) (PVB), Polytetrafluoroethylene (PTFE), Polyvinyl Alcohol (PVA), perfluorosulfonic acid polymer, Polyimide (PI), poly(methyl methacrylate) (PMMA), Ethylene Propylene Diene Monomer (EPDM), Polyethylene Oxide (PEO), Polyurethane (PU), Polytetrafluoroethylene (PTFE), Poly(vinyl butyral) (PVB), and latex-based binders in combination with CMC or SBR. Examples of the conductive diluents include but are not limited to a SWCNT (single walled carbon nanotubes) , Super P, Super C65, and Poly Acryilic Acid (PAA). Examples, of additives include but are not limited to lithium tungsten oxide (LWO) and lithium titanium oxide (LTO).

At 404, adding 40 to 50% by weight of water solvent to the admixture to form a slurry having a viscosity greater than 3000 mPa·s. In an embodiment, the viscosity of the slurry is maintained from 3000 to 6000 millipascal-second (mPa·s). This slurry plays a critical role in ensuring the even distribution of materials and achieving a consistent coating during electrode fabrication.

In an embodiment, the viscosity of the slurry is controlled to fall within a range of 3000 to 6000 millipascal-seconds (mPa·s). Maintaining this specific viscosity range is essential for achieving the desired flow characteristics of the slurry. A viscosity greater than 3000 mPa·s ensures that the slurry is adequately thick and cohesive, preventing segregation of the components during mixing or handling. At the same time, a maximum viscosity of 6000 mPa·s allows for ease of coating onto the conductive foil, ensuring uniformity in the application and adherence of the electrode layer.

The precise control of viscosity also influences the pore structure and distribution within the dried electrode, impacting its electrochemical performance. A well-balanced slurry viscosity is crucial for producing electrodes with optimal mechanical strength, conductivity, and porosity, thereby enhancing the overall efficiency and reliability of the resulting electrochemical cells.

At 406, the slurry is coated onto a conductive foil to form a layer of coat on the electrode. In an example, the conductive foil is a copper foil, and a thickness of the combination coated on the copper foil ranges from 70 μm to 90 μm.

At 408, the coated electrode is dried at a high temperature ranging from 40 to 120 degree Celsius, to obtain the electrode. Typically, a slow rate of heating ensures better adherence of the coat on the foil. Slow heating allows for water in the slurry to evaporate at a steady rate, preventing rapid drying, which could lead to cracks, delamination, or uneven coating due to localized stress. Moreover, the slower evaporation promotes better adhesion of the active material and binder mixture to the conductive foil by allowing the binders sufficient time to form strong chemical and physical bonds with both the active material and the conductive foil substrate.

This meticulous drying process also ensures a more homogeneous distribution of pores within the electrode, which is critical for optimizing ionic and electronic conductivity during battery operation. By controlling a drying temperature and rate, the process avoids thermal degradation of sensitive materials, such as binders, conductive additives, or the active material itself, preserving the electrode's structural and electrochemical integrity. Disclosed drying thus plays a pivotal role in achieving the desired electrode thickness, porosity, and mechanical robustness, all of which contribute to the overall performance and longevity of the electrochemical cell.

At 410, the coated electrode is calendared by applying pressure to reduce the thickness of the layer of coat to 70 μm to 90 μm. The process of calendaring involves passing the dried, coated electrode through a pair of rollers under controlled pressure. The objective is to compress the coated material to achieve a uniform thickness (typically 70 μm to 90 μm in this case) while retaining the desired porosity for efficient electrochemical performance.

This shows a great efficiency of the cell as it maintains a stable voltage over the majority of its capacity, delivering most of its charge with minimal voltage drop, which is a hallmark of high-performance energy storage. Here's the analysis:

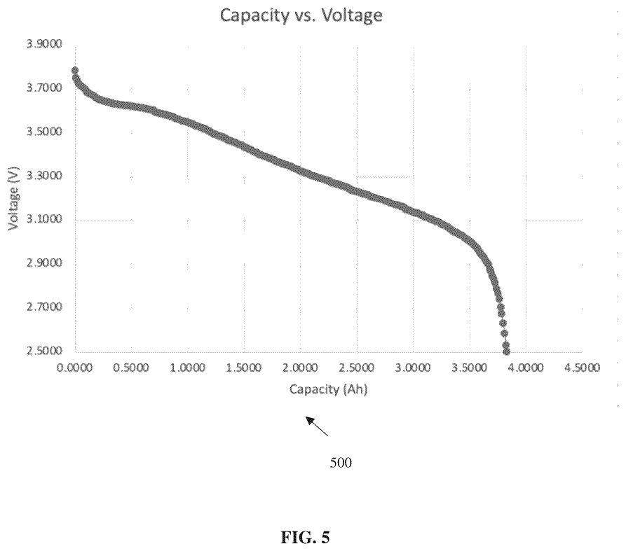

FIG. 5 illustrates a graph 500 depicting voltage as a function of the electrode's capacity during continuous discharge, in accordance with an example embodiment. The x-axis represents the capacity of the electrode, typically measured in ampere-hours (Ah), while the y-axis represents the voltage of the electrode, measured in volts (V).

The graph highlights the cell's performance during discharge. Initially, the voltage exhibits a gradual decrease from 3.8V to 3.0V as 3.5 Ah of capacity is discharged, which constitutes a significant portion (about 92%) of the battery's total capacity (3.8 Ah). This showcases a stable voltage profile over a significant portion of the electrode's capacity. This indicates the cell operates efficiently and provides a consistent energy output over a large portion of its charge, crucial for applications requiring steady performance.

Subsequently, a sharper voltage drop occurs from 3.0V to 2.5V as the remaining 0.3 Ah of capacity is discharged. It is to be noted that the remaining 0.3 Ah is around 8% of the total capacity of the cell. This steep decline is typical of battery behavior as the remaining active material is exhausted. Importantly, the sharp drop occurs only near the end of the discharge cycle, maximizing usable capacity before performance deteriorates.

The cell effectively utilizes most of its charge (3.5 Ah out of 3.8 Ah) while maintaining high voltage levels, translating to reduced energy losses and efficient power delivery. The energy delivered is proportional to voltage ×capacity, and the higher, stable voltage during the initial discharge ensures maximum energy extraction.

Batteries with such characteristics are ideal for applications requiring long runtimes, as they provide a stable power supply without frequent recharging or performance fluctuations. In summary, the ability of the cell to maintain a stable voltage (3.8V to 3.0V) while delivering 92% of its capacity highlights its efficiency, reliability, and suitability for high-demand applications. The steep voltage drop only near the end ensures maximum utility of its capacity without premature performance degradation.

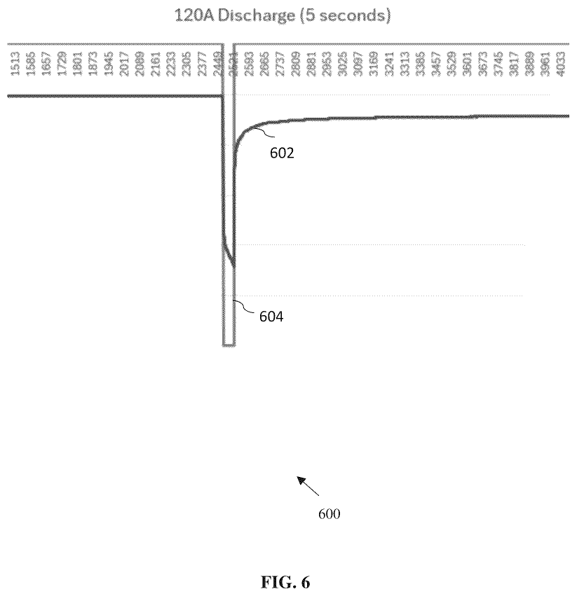

FIG. 6 is a graph 600 illustrating a pulse discharge of current and voltage of a cell, according to an example embodiment. The graph shows impact on the cell when 120A current discharges in 5 seconds. The voltage drops to 3.6 volts and stabilizes back to 4.2 volts, which is the original stable state of the cell. The graph highlights the voltage sag observed during a 120A discharge, which is indicative of the battery's internal resistance. Despite the high discharge current, the voltage exhibits a smooth recovery back to 4.2V after the discharge, demonstrating the battery's stability and resilience, both of which are critical for consistent performance.

The ability of the battery to sustain such a high discharge current without significant long-term voltage instability underscores its strong rate capability and efficient energy delivery. The voltage drop to 3.6V during discharge and its subsequent stabilization near its original state show the battery's robust design and capacity to handle demanding conditions. This makes it suitable for applications requiring high power output without compromising the overall health and longevity of the battery.

For example, the dried electrode is fed into a calendaring machine equipped with precision rollers. The precision rollers are made of hard material like steel, tungsten carbide to provide uniform pressure of 20 MPa to 100 MPa. The pressure is adjusted to balance compression without causing structural damage or delamination of the coating from the foil. Further, the electrode is passed through the rollers at a controlled speed to ensure consistent compression. The duration of pressure application depends on the machine settings but is typically, in the range of milliseconds to a few seconds per pass. Multiple passes through the rollers are done to achieve the desired thickness and density of the coat. Incremental adjustments of 2 MPa in the pressure levels in each pass is done to ensure a uniform thickness of coat.

Due to the calendaring process, the overall porosity of the electrode is reduced, as the active material SiOx and graphite is compressed to the binder. Pore reduction that occurs during the calendaring process provides improved mechanical stability and electronic conductivity, as smaller pores with increased density improve an ionic conductivity and a surface area for electrolyte contact. The controlled calendaring process ensures that the electrode's pore structure supports high energy density, and power density. A specific energy density of the electrode obtained by disclosed method, is at least 200 Wh/Kg, and a power density is at least 5000 W/Kg. Further, the capacity of the electrode ranges from 4 Ah to 5 Ah.

The disclosed invention provides substantial advancements in the design and fabrication of high-performance electrodes for electrochemical cells, particularly for applications requiring high power densities. It incorporates an enhanced material composition, utilizing advanced conductive diluents like single-walled carbon nanotubes (SWCNTs), Super P, Super C65, and polyacrylic acid (PAA) to significantly improve electronic conductivity. Additives such as lithium tungsten oxide (LWO) and lithium titanium oxide (LTO) are included to enhance electrochemical performance and stability. The slurry formulation is meticulously optimized to achieve a controlled viscosity range of 3000 to 6000 mPa·s, ensuring a uniform distribution of active materials, binders, and conductive diluents. This uniformity minimizes segregation and ensures consistent coating on conductive foils, such as copper, leading to superior electrode reliability and performance.

The coating process is designed to uniformly apply a slurry layer with a thickness of 70 μm to 90 μm, resulting in a high-quality electrode with reduced defects and enhanced electrochemical and mechanical properties. A carefully executed drying protocol, maintained at temperatures between 40° C. and 120° C., prevents rapid evaporation, allowing better adherence of the coating to the conductive foil. This slow drying approach minimizes the risks of cracks, delamination, and uneven distribution while optimizing the electrode's porosity for improved ionic and electronic conductivity. Furthermore, the calendaring process employs controlled pressure, ranging from 20 MPa to 100 MPa, to compress the coated material into a uniform thickness while preserving the desired porosity. This balance ensures mechanical stability and porosity, leading to an electrode with enhanced energy density (at least 200 Wh/Kg) and power density (at least 5000 W/Kg).

The resulting electrode exhibits impressive electrochemical metrics, including a capacity of 4 Ah to 5 Ah, a discharge rate of at least 25 C for pulse power, and 11 C for continuous power. Such performance metrics make the electrode highly suitable for demanding applications, such as electric vehicles, air mobility systems, and power tools. Additionally, the disclosed methods and materials are scalable for large-scale production, ensuring consistency and quality. The choice of binders, diluents, and additives offers versatility in customizing the electrode for specific applications and performance requirements.

By addressing critical parameters such as material composition, viscosity control, drying techniques, and calendaring, this invention significantly enhances the efficiency, reliability, and longevity of electrochemical cells. It represents a valuable breakthrough in battery technology, offering scalable solutions for next-generation energy storage systems.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in a different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the example embodiments described are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

We claim:

1. An electrode for use in an electrochemical cell, the electrode comprising a composition of:
an electroactive material comprising a combination of silicon oxide with a structure of SiOₓ 0.1≤x≤2.0 and graphite in a range of 90-95% by weight;
one or more binders in a range of 4-6% by weight;
one or more conductive diluents including SWCNT (single walled carbon nanotubes), Super P, Super C65, and Poly Acryilic Acid (PAA) in a range of 2 to 4% by weight; and
a water-based solvent in a range of 40-50% by weight, coated onto a conductive foil and dried to form the electrode.

2. The electrode of claim 1, wherein the one or more binders are selected from polyvinylidene fluoride (PVDF), styrene-butadiene rubber (SBR), and carboxymethyl cellulose (CMC), Poly(vinyl butyral) (PVB), Polytetrafluoroethylene (PTFE), Polyvinyl Alcohol (PVA), perfluorosulfonic acid polymer, Polyimide (PI), poly(methyl methacrylate) (PMMA), Ethylene Propylene Diene Monomer (EPDM), Polyethylene Oxide (PEO), Polyurethane (PU), Polytetrafluoroethylene (PTFE), Poly(vinyl butyral) (PVB), and latex-based binders in combination with CMC or SBR.

3. The electrode of claim 1, further comprising:
an additive selected from lithium tungsten oxide (LWO) and lithium titanium oxide (LTO), in a range of 5 to 15 % by weight.

4. The electrode of claim 1, wherein the combination is a viscous slurry having viscosity of 3000-6000 millipascal-second (mPa·s), and wherein the combination is coated on the conductive foil at a temperature ranging from 40 to 120 degree Celsius.

5. The electrode of claim 1, wherein the conductive foil is a copper foil, and wherein a thickness of the combination coated on the copper foil ranges from 70 μm to 90 μm.

6. The electrode of claim 1, wherein a specific energy density of the electrode exhibited is at least 200 Wh/Kg, a power density is at least 5000 W/Kg, and a capacity ranges from 4 Ah to 5 Ah.

7. The electrode of claim 1, wherein a discharge rate exhibited by the electrode is at least 25 C for pulse power, and is at least 11 C for continuous power, wherein the electrode continuously discharges at least at 45 Amperes.

8. A method of manufacturing an electrode for an electrochemical cell, the method comprising:
mixing silicon oxide (SiOₓ), graphite, binders, additives, and conductive diluents in a mixer jar to form an admixture;
adding 40 to 50% by weight of water solvent to the admixture to form a slurry having a viscosity greater than 3000 mPa·s;
coating the slurry onto a conductive foil to form a layer of coat on the electrode; and
drying the coated electrode at a high temperature ranging from 40 to 120 degree Celsius, to obtain the electrode.

9. The method of claim 8, wherein the binders comprise one or more of polyvinylidene fluoride (PVDF), styrene-butadiene rubber (SBR), and carboxymethyl cellulose (CMC), Poly(vinyl butyral) (PVB), Polytetrafluoroethylene (PTFE), Polyvinyl Alcohol (PVA), perfluorosulfonic acid polymer, Polyimide (PI), poly(methyl methacrylate) (PMMA), Ethylene Propylene Diene Monomer (EPDM), Polyethylene Oxide (PEO), Polyurethane (PU), Polytetrafluoroethylene (PTFE), Poly(vinyl butyral) (PVB), and latex-based binders in combination with CMC or SBR, and a mixed in a weight ratio of 4-6%.

10. The method of claim 8, wherein the conductive diluents comprise one or more of a SWCNT (single walled carbon nanotubes ), Super P, Super C65, and Poly Acryilic Acid (PAA) and are mixed in a weight ratio of 2 to 4%.

11. The method of claim 8, wherein an additive selected from lithium tungsten oxide (LWO) and lithium titanium oxide (LTO), and wherein the additive is mixed in a ratio of 5 to 15% by weight.

12. The method of claim 8, further comprising:
calendaring the coated electrode by applying pressure to reduce a thickness of the layer of coat to 70 μm to 90 μm.

13. The method of claim 8, wherein a pore density of the electrode is 30 to 75%.

14. The method of claim 8, wherein a capacity of the electrode ranges up to 5 Ah.

15. The method of claim 8, wherein a specific energy density of the electrode exhibited is at least 200 Wh/Kg, and a power density is at least 5000 W/Kg.

16. The method of claim 8, wherein a discharge rate exhibited by the electrode is at least 25 C for pulse power, and is at least 11 C for continuous power, wherein the electrode continuously discharges at least at 45 Amperes.

17. An electrochemical device comprising:
a negative electrode comprising a combination of an electroactive material comprising a combination of silicon oxide with a structure of SiOx 0.1≤x≤2.0 and graphite in a range of 90-95% by weight, one or more binders in a range of 4-6% by weight, and one or more conductive diluents including SWCNT (single walled carbon nanotubes ), Super P, Super C65, and Poly Acryilic Acid (PAA) in a range of 2 to 4% by weight, in 40-50% of water, wherein the combination is coated and dried on a conductive foil, and wherein the negative electrode is in electronic contact with a negative current collector in electric connection with an external circuit;
a positive electrode in electronic contact with a positive current collector in electric connection with the external circuit;
a separator positioned between the positive electrode and the negative electrode; and
an electrolyte in ionic contact with the positive and negative electrodes.

18. The electrochemical device of claim 17, wherein the one or more binders are selected from polyvinylidene fluoride (PVDF), styrene-butadiene rubber (SBR), and carboxymethyl cellulose (CMC), Poly(vinyl butyral) (PVB), Polytetrafluoroethylene (PTFE), Polyvinyl Alcohol (PVA), perfluorosulfonic acid polymer, Polyimide (PI), poly(methyl methacrylate) (PMMA), Ethylene Propylene Diene Monomer (EPDM), Polyethylene Oxide (PEO), Polyurethane (PU), Polytetrafluoroethylene (PTFE), Poly(vinyl butyral) (PVB), and latex-based binders in combination with CMC or SBR.

19. The electrochemical device of claim 17, further comprising:
an additive selected from lithium tungsten oxide (LWO) and lithium titanium oxide (LTO), in a range of 5 to 15% by weight.

20. The electrochemical device of claim 17, wherein the conductive foil is a copper foil, and wherein a thickness of the combination coated on the copper foil ranges from 70 μm to 90 μm.
